(19) United States
(12) Patent Application Publication
(10) Pub. No.: US 2009/0207450 A1
(43) Pub. Date: Aug. 20, 2009

(54) IMAGE SCANNING APPARATUS, SHADING CORRECTION METHOD, AND SHADING CORRECTION PROGRAM

(75) Inventor: Katsuya Nagamochi, Ota-ku (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/369,270

(22) Filed: Feb. 11, 2009

Related U.S. Application Data
(60) Provisional application No. 61/029,864, filed on Feb. 19, 2008.

(51) Int. Cl. G06K 15/00

(52) U.S. Cl. 358/2.1

(57) ABSTRACT

A technique is provided that can realize highly accurate shading correction with a simple configuration. A light amount of illumination light on a predetermined illumination target by a light source is controlled such that reflected light having a first luminance value as predetermined black reference data, reflected light having a second luminance value as predetermined white reference data, and reflected light having another luminance value as at least one value between the first luminance value and the second luminance value can be obtained. Information concerning the luminance of reflected light obtained by illuminating the predetermined illumination target with the light source, the light amount of which is controlled, is acquired. Shading correction is performed on the basis of the acquired information.

### CROSS-REFERENCE TO RELATED APPLICATION

This application is based upon and claims the benefit of priority from U.S. provisional application 61/029,864 filed on Feb. 19, 2008, the entire contents of which is incorporated herein by reference.

### TECHNICAL FIELD

The present invention relates to a shading correction technique in an image scanning apparatus.

### BACKGROUND

Techniques explained in (1) to (6) below are known concerning shading correction in an image scanning apparatus.

(1) A technique for detecting, in order to grasp a sensitivity characteristic of a light-receiving element array, a reference chart corresponding to intermediate density other than a white reference plate (a so-called shading plate) and performing correction processing for the sensitivity characteristic.
(2) A technique for arranging a neutral filter on an optical path and performing correction processing for a sensitivity characteristic on the basis of reflected light corresponding to intermediate density detected by switching the neutral filter (see, for example, JP-A-5-63978).
(3) A technique for scanning an original document with plural sensors at a predetermined intermediate level between a white level and a black level and reducing fluctuation in outputs of the respective sensors at the intermediate level according to correction data (see, for example, JP-A-5-63977).
(4) A technique for creating a histogram from luminance data of an original document, changing a light amount of a halogen lamp to have a largest frequency value, and calculating a shading correction coefficient (a coefficient for multiplying a calculation result after shading correction) (see, for example, JP-A-7-144336).
(5) A technique for performing correction by linear approximation from one kind of half tone chart and a detection result of a white reference plate using a light source, a light amount of which can be adjusted at two stages (see, for example, JP-A-5-3545).
(6) A technique for providing plural light sources and changing a light amount of illumination light used during shading correction by changing the number of light sources that are a cause to emit light (see, for example, JP-A-2002-118745). In this related art, the light amount is changed at two stages.

However, there are problems explained below in the related arts (1) to (6).

In the related art (1), it is difficult to manage the reference chart corresponding to the intermediate density.

In the related art (2), in a contact image sensor including a nonmagnification optical system in an image scanning apparatus, since a configuration for changing the neutral filter is adopted, complication and an increase in size of an apparatus configuration are caused.

In the related art (3), since correction is performed only at a specific level in the middle of the white level and the black level, the correction is not sufficiently performed for density other than the corrected intermediate level. Further, since the correction data is calculated for all pixels, arithmetic processing for a correction value takes time and a capacity of a storage area for storing correction value for all the pixels increases.

In the related art (4), since the histogram is created on the basis of scanned image data of the original document, correction operation takes time. Further, since correction data is calculated for all pixels, arithmetic processing for a correction value takes time and a capacity of a storage area for storing correction values for all the pixels increases.

In the related art (5), although intermediate density, a white level, and a black level as references can be corrected, since the sensitivity of a sensor is nonlinear, other densities cannot be sufficiently corrected.

In the related art (6), although one of two light sources is turned off to generate a signal corresponding to intermediate density, correction at densities other than the specific intermediate density cannot be performed.

### SUMMARY

It is an object of an embodiment of the present invention to provide a technique that can realize highly accurate shading correction with a simple configuration.

In order to solve the problems, according to an aspect of the present invention, there is provided an image scanning apparatus including: a light source that illuminates a predetermined illumination target; a light-amount control unit that controls a light amount of illumination light on the predetermined illumination target by the light source such that reflected light having a first luminance value as predetermined black reference data, reflected light having a second luminance value as predetermined white reference data, and reflected light having another luminance value as at least one value between the first luminance value and the second luminance value can be obtained; a luminance-information acquiring unit that acquires information concerning the luminance of reflected light obtained by illuminating the predetermined illumination target with the light source, the light amount of which is controlled by the light-mount control unit; and a correction processing unit that performs shading correction on the basis of information acquired by the luminance-information acquiring unit.

According to another aspect of the invention, there is provided an image scanning apparatus including: a light source that illuminates a predetermined illumination target; a sensor that detects the luminance of reflected light from the predetermined illumination target illuminated by the light source; a light-amount control unit that controls a light reception amount in the sensor by changing charge accumulation time in the sensor such that reflected light having a first luminance value as predetermined black reference data, reflected light having a second luminance value as predetermined white reference data, and reflected light having other luminance values as at least one value between the first luminance value and the second luminance value are received in the sensor; a luminance-information acquiring unit that acquires information concerning the luminance of the reflected light detected by the sensor; and a correction processing unit that performs shading correction on the basis of information acquired by the luminance-information acquiring unit.

According to still another aspect of the invention, there is provided a shading correction method including: controlling a light amount of illumination light on a predetermined illumination target by a light source such that reflected light having a first luminance value as predetermined black reference data, reflected light having a second luminance value as predetermined white reference data, and reflected light having other luminance values as at least one value between the first luminance value and the second luminance value are obtained; acquiring information concerning the luminance of reflected light obtained by illuminating the predetermined illumination target with the light source, the light amount of which is controlled; and performing shading correction on the basis of the acquired information.

According to still another aspect of the invention, there is provided a shading correction program for causing a computer to execute processing for: controlling a light amount of illumination light on a predetermined illumination target by a light source such that reflected light having a first luminance value as predetermined black reference data, reflected light having a second luminance value as predetermined white reference data, and reflected light having other luminance values as at least one value between the first luminance value and the second luminance value are obtained; acquiring information concerning the luminance of reflected light obtained by illuminating the predetermined illumination target with the light source, the light amount of which is controlled; and performing shading correction on the basis of the acquired information.

### DESCRIPTION OF THE DRAWINGS

FIG. 1 is a longitudinal sectional view of an overall configuration of an image processing apparatus including an image scanning apparatus according to a first embodiment of the invention;

FIG. 2 is a sectional view for explaining a configuration of a scanning optical system in the image scanning apparatus according to the first embodiment;

FIG. 3 is a schematic diagram of details of sensor arrays in the scanning optical system in the image scanning apparatus according to the first embodiment;

FIG. 4 is a functional block diagram for explaining a configuration of the image scanning apparatus according to the first embodiment;

FIG. 5 is a flowchart of a flow of processing (a shading correction method) according to the first embodiment;

FIG. 6 is a flowchart of the flow of the processing (the shading correction method) according to the first embodiment;

FIG. 7 is an input and output characteristic graph for explaining fluctuation in linearity before the shading correction processing is performed;

FIG. 8 is a graph for explaining linearity after the shading correction processing is performed;

FIG. 9 is a graph for explaining a method of calculating a linear correction equation;

FIG. 10 is a diagram for explaining a relation among a forward current and a light emission amount of an LED, a CCD output, and linearity;

FIG. 11 is a diagram for explaining generation of a half tone by a change of LED light emission time; and

FIG. 12 is a diagram for explaining generation of a half tone by a change of charge accumulation time.

### DETAILED DESCRIPTION

Embodiments of the invention are explained below with reference to the accompanying drawings.

### First Embodiment

First, a first embodiment of the invention is explained.

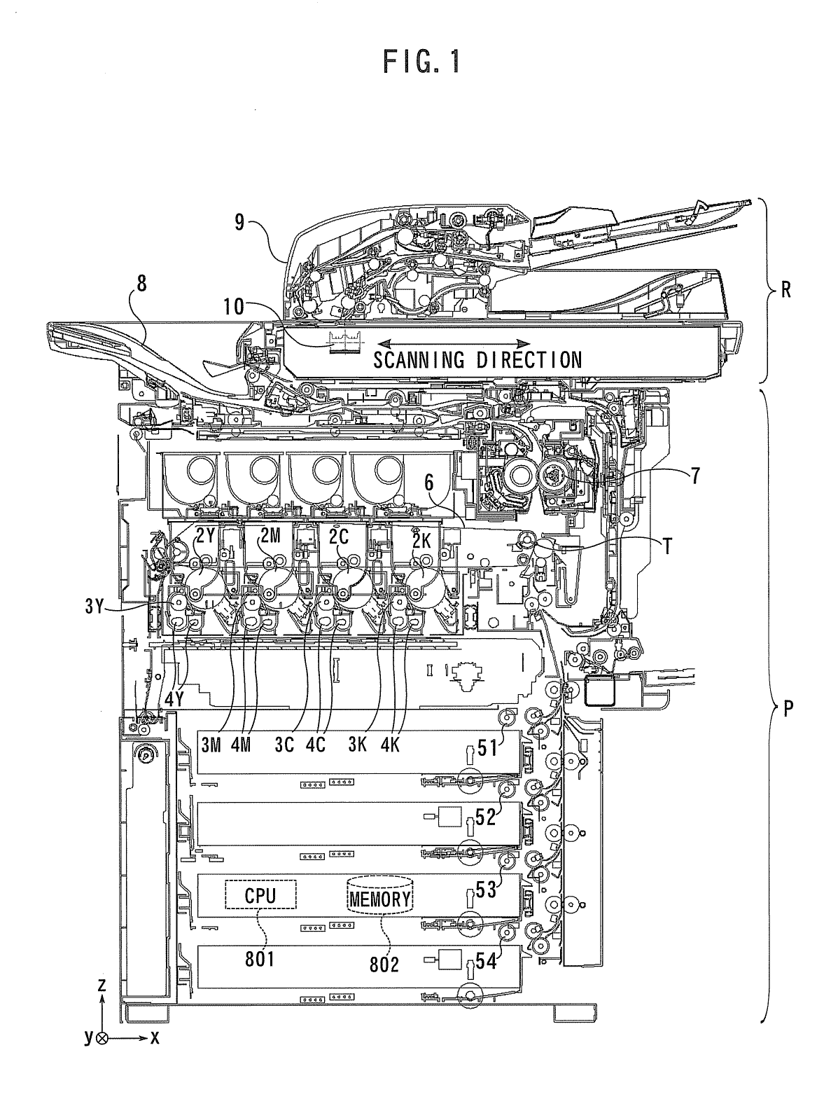

FIG. 1 is a longitudinal sectional view of an overall configuration of an image processing apparatus (MFP: Multi Function Peripheral) including an image scanning apparatus according to the first embodiment.

As shown in FIG. 1, the image processing apparatus according to this embodiment includes an image scanning unit R (equivalent to the image scanning apparatus) and an image forming unit P.

The image scanning unit R has a function of scanning images of a sheet original document and a book original document.

The image forming unit P has a function of forming a developer image on a sheet on the basis of an image scanned from an original document by the image scanning unit R, image data transmitted from an external apparatus to the image processing apparatus, or the like.

The image scanning unit R includes an auto document feeder (ADF) 9 that can automatically feed an original document to a predetermined image scanning position. The image scanning unit R scans, using a scanning optical system 10, an image of an original document automatically fed by the auto document feeder 9 and placed on a document tray (a predetermined document placing table) Rt or an image of an original document placed on a not-shown document table. The image of the original document placed on the document table is scanned by the scanning optical system 10 that moves in a sub-scanning direction (equivalent to an x direction in FIG. 1).

The image forming unit P includes pickup rollers 51 to 54, photoconductive members 2Y to 2K, developing rollers 3Y to 3K, mixers 4Y to 4K, an intermediate transfer belt 6, a fixing device 7, and a discharge tray 8.

The image processing apparatus according to this embodiment further includes a CPU 801 and a memory 802 (see FIG. 1). The CPU 801 has a role of performing various kinds of processing in the image processing apparatus and also has a role of realizing various functions by executing programs stored in the memory 802. The memory 802 can be configured by, for example, a RAM (Random Access Memory), a ROM (Read Only Memory), a DRAM (Dynamic Random Access Memory), an SRAM (Static Random Access Memory), a VRAM (Video RAM) or the like. The memory 802 has a role of storing various kinds of information and programs that are used in the image processing apparatus.

As an example of processing in the image processing apparatus according to this embodiment, an overview of copy processing is explained.

First, sheets picked up from cassettes by the pickup rollers 51 to 54 are fed into a sheet conveying path. The sheets fed into the sheet conveying path are conveyed in a predetermined conveying direction by plural roller pairs.

Images of plural sheet original documents automatically conveyed continuously by the auto document feeder 9 are scanned by the scanning optical system 10 in the predetermined image scanning position.

On the basis of image data of the images scanned from the original documents by the image scanning unit R, electrostatic latent images are formed on photoconductive surfaces of the photoconductive members 2Y, 2M, 2C, and 2K for transferring developer images of yellow (Y), magenta (M), cyan (C), and black (K) onto the sheets.

Subsequently, developers agitated by the mixers 4Y to 4K (equivalent to agitating units) in a developing device are supplied to the photoconductive members 2Y to 2K, on which the electrostatic latent images are formed as explained above, by the developing rollers (so-called mug rollers) 3Y to 3K. Consequently, the electrostatic latent images formed on the photoconductive surfaces of the photoconductive members 2Y, 2M, 2C, and 2K are visualized.

Developer images formed on the photoconductive members 2Y, 2M, 2C, and 2K in this way are transferred onto a belt surface of the intermediate transfer belt 6 (so-called primary transfer). The developer images carried according to the rotation of the intermediate transfer belt 6 are transferred onto the conveyed sheets in a predetermined secondary transfer position T.

The developer images transferred onto the sheets are heated and fixed on the sheets by the fixing device 7.

The sheets on which the developer images are heated and fixed are conveyed through a conveying path by the plural conveying roller pairs and sequentially discharged onto the discharge tray 8.

The image scanning unit R in this embodiment performs shading correction processing at predetermined timing in order to correct light amount unevenness caused when the image scanning unit R scans an image.

In this embodiment, the scanning optical system 10 in the image scanning unit R scans a predetermined white reference plate and a predetermined black reference plate to thereby acquire input data corresponding to an image having uniform density distributions of white and black and perform correction for setting the input data as reference values of white and black. This makes it possible to correct illuminance unevenness and element fluctuation of image data.

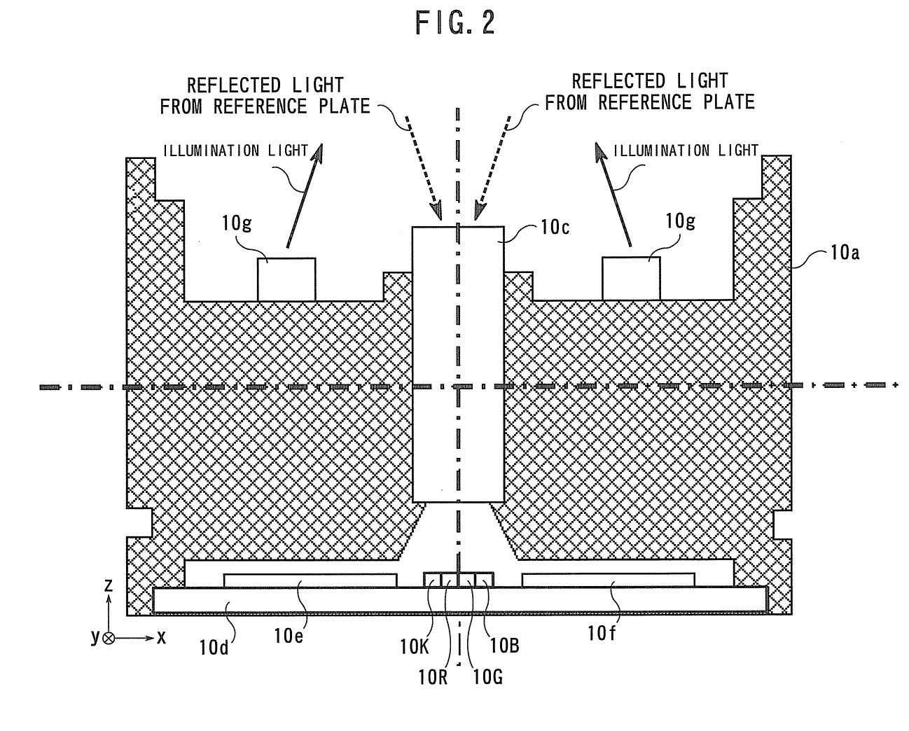

FIG. 2 is a sectional view for explaining a configuration of the scanning optical system 10 (a contact image sensor module) in the image scanning apparatus according to this embodiment.

The scanning optical system 10 includes a housing 10a, a light source 10g, a rod lens array 10c, sensor arrays 10K to 10B, sensor driving ICs 10e and 10f, and a sensor substrate 10d.

Since the sensor arrays 10K to 10B are directly mounted on the sensor substrate 10d, the scanning optical system 10 is closed to prevent dust and the like from entering the inside of the module. Therefore, the sensor arrays 10K to 10B cannot be replaced after being incorporated in the scanning optical system 10 as a module. A sensitivity characteristic of a light-receiving element does not change with time.

Therefore, when the sensor arrays 10K to 10B are replaced during manufacturing of the image scanning apparatus or replaced in a setting place for the image scanning apparatus, a correction amount is stored in the memory 802 or the like in advance. When shading correction is actually performed, it is possible to obtain an image with less image defects such as a density difference due to the influence of fluctuation in linearity by using the correction value stored in advance.

The light source 10g can be configured by, for example, an LED. When the LED is adopted as the light source 10g, it is possible to easily realize an output of a signal level equivalent to a half tone according to a change of a light amount, a change of light emission time, or a change of charge accumulation time of the sensor arrays.

A configuration of the scanning optical system 10 is not always limited to the configuration explained above. For example, the scanning optical system 10 can be a one-line sensor including only the sensor array 10K. Besides, it goes without saying that the scanning optical system 10 can be a three-line sensor including only the sensor arrays 10R 10G, and 10B in order to detect black data from red, green, and blue image data with arithmetic processing.

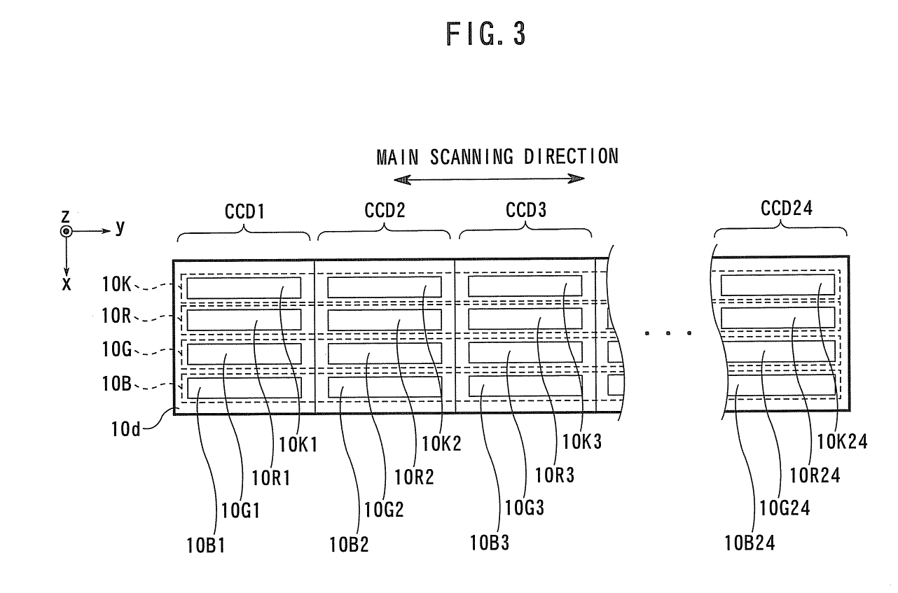

FIG. 3 is a schematic diagram of details of the sensor arrays 10K to 10B in the scanning optical system 10 in the image scanning apparatus according to this embodiment. The scanning optical system 10 in the image scanning apparatus according to this embodiment is a so-called four-line image sensor including plural light-receiving element arrays that convert focused light into an electric signal.

Specifically, the sensor arrays 10K to 10B extending in a main scanning direction are arrayed to be adjacent to one another in the sub-scanning direction. Each of the sensor arrays 10K to 10B includes, for example, twenty-four sensor chips (CCD 1 to CCD 24) arrayed in the main scanning direction. Each of the sensor chips includes CCD elements for, for example, 312 pixels in the main scanning direction.

In the scanning optical system 10 having the configuration explained above, when an original document as a target of image scanning processing is illuminated by the light source 10g, light reflected by the original document is focused on the sensor arrays 10K to 10B by the rod lens array 10c. The light led to the sensor arrays 10K to 10B is converted into an electric signal.

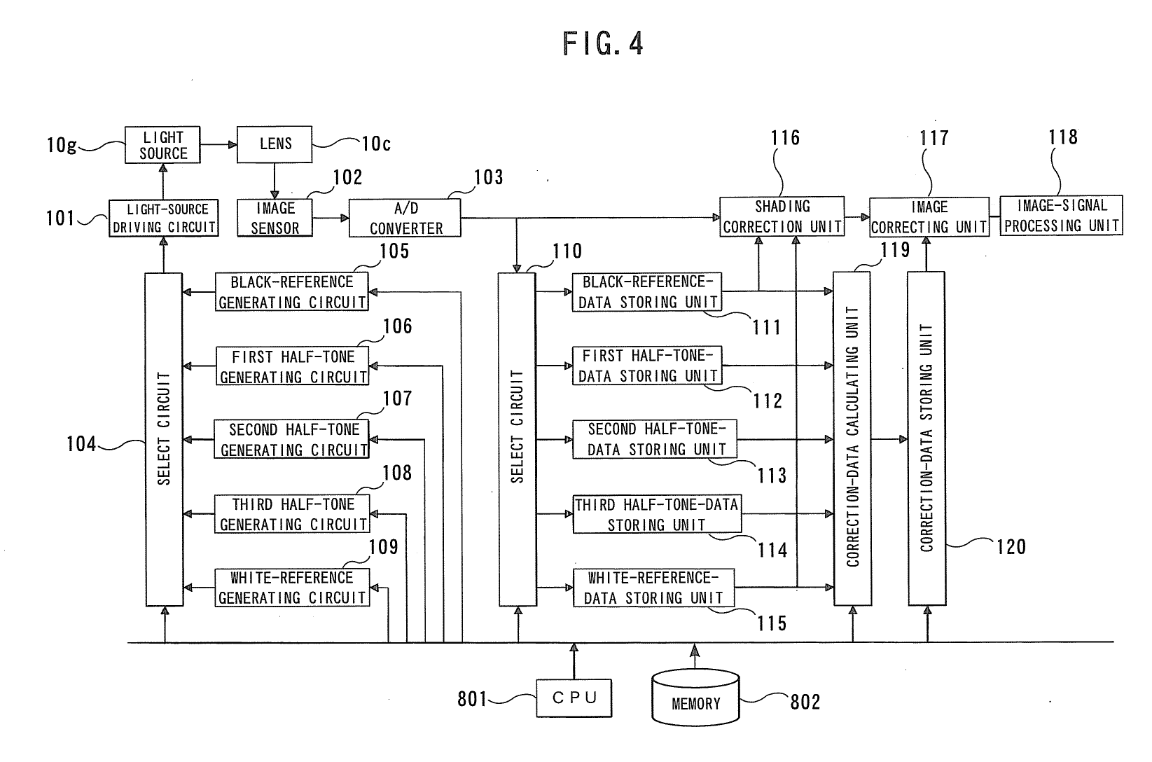

FIG. 4 is a functional block diagram for explaining a configuration of the image scanning apparatus according to this embodiment.

As shown in the figure, the image scanning apparatus according to this embodiment includes the light source 10g, the lens 10c, a light-source driving circuit 101, an image sensor 102, an A/D converter 103, a select circuit 104, a black-reference generating circuit 105, a first half-tone generating circuit 106, a second half-tone generating circuit 107, a third half-tone generating circuit 108, a white-reference generating circuit 109, a select circuit 110, a black-reference-data storing unit 111, a first half-tone-data storing unit 112, a second half-tone-data storing unit 113, a third half-tone-data storing unit 114, a white-reference-data storing unit 115, a shading correction unit 116, an image correcting unit 117, an image-signal processing unit 118, a correction-data calculating unit 119, a correction-data storing unit 120, the CPU 801, and the memory 802.

The light-source driving circuit 101 is connected to the light source 10g and controls a light emitting condition of the light source 10g.

The image sensor 102 is equivalent to the sensor arrays 10K to 10B.

The A/D converter 103 converts an output signal of the image sensor 102 into a digital signal.

The select circuit 104 selects any one of the black-reference generating circuit 105 to the white-reference generating circuit 109.

The select circuit 110 selects any one of the black-reference-data storing unit 111 to the white-reference-data storing unit 115.

The black-reference generating circuit 105, the first half-tone generating circuit 106, the second half-tone generating circuit 107, the third half-tone generating circuit 108, and the white-reference generating circuit 109 are connected to the select circuit 104.

The black-reference generating circuit 105 controls a light amount of the light source 10g such that a luminance value as a reference of black in setting a driving condition of the light-source driving circuit 101 can be acquired.

The first half-tone generating circuit 106 generates a forward current for causing the light source 10g to emit light in order to obtain reflected light at first reflectance larger than 0% and smaller than 100%.

The second half-tone generating circuit 107 generates a forward current for causing the light source 10g to emit light in order to obtain reflected light at second reflectance larger than 0% and smaller than 100%.

The third half-tone generating circuit 108 generates a forward current for causing the light source 10g to emit light in order to obtain reflected light at third reflectance larger than 0% and smaller than 100%.

The white-reference generating circuit 109 controls a light amount of the light source 10g such that a luminance value as a reference of white in setting a driving condition of the light-source driving circuit 101 can be acquired.

The black-reference-data storing unit 111 acquires and stores information (e.g., reflectance, a luminance value, lightness, and a density value) concerning the luminance of reflected light of illumination light from the light source 10g caused to emit light by the forward current generated by the black-reference generating circuit 105.

The first half-tone-data storing unit 112 acquires and stores information concerning the luminance of reflected light of illumination light from the light source 10g caused to emit light by the forward current generated by the first half-tone generating circuit 106.

The second half-tone-data storing unit 113 acquires and stores information concerning the luminance of reflected light of illumination light from the light source 10g caused to emit light by the forward current generated by the second half-tone generating circuit 107.

The third half-tone-data storing unit 114 acquires and stores information concerning the luminance of reflected light of illumination light from the light source 10g caused to emit light by the forward current generated by the third half-tone generating circuit 108.

The white-reference-data storing unit 115 acquires and stores information concerning the luminance of reflected light of illumination light from the light source 10g caused to emit light by the forward current generated by the white-reference generating circuit 109.

The shading correction unit 116 performs shading correction to a digital signal corresponding to reflected light from an original document on the basis of the data stored in the black-reference-data storing unit 111, the first half-tone-data storing unit 112, the second half-tone-data storing unit 113, the third half-tone-data storing unit 114, and the white-reference-data storing unit 115.

The correction-data calculating unit 119 calculates a correction amount used in the image correcting unit 117 on the basis of the data stored in the black-reference-data storing unit 111, the first half-tone-data storing unit 112, the second half-tone-data storing unit 113, the third half-tone-data storing unit 114, and the white-reference-data storing unit 115.

The correction-data storing unit 120 stores the correction amount used in the image correcting unit 117.

The image correcting unit 117 performs correction of image data after the shading correction using the correction data stored in the correction-data storing unit 120.

The image-signal processing unit 118 executes predetermined signal processing on the basis of the image data corrected by the image correcting unit 117.

Details of functions of the respective components configuring the image scanning apparatus according to this embodiment are explained below.

The black-reference generating circuit 105 to the white-reference generating circuit 109, the select circuit 104, and the light-source driving circuit 101 (these circuits are equivalent to the light-amount control unit) control a light amount of illumination light illuminated on a white reference plate and a black reference plate (equivalent to the predetermined illumination target) by the light source 10g such that (1) reflected light having a “first luminance value” as predetermined black reference data, (2) reflected light having a “second luminance value” as predetermined white reference data, and (3) reflected light having “another luminance value” as at least one value between the first luminance value and the second luminance value can be obtained.

Specifically, the light-source driving circuit 101 controls the light amount by changing a forward current amount supplied to the LED configuring the light source 10g.

The light-source driving circuit 101 controls a light emission amount of the light source 10g such that “another luminance value” is a value closer to the “first luminance value” than a median in a range from the “first luminance value” to the “second luminance value”.

The light-amount control unit controls the light source 10g such that, when the “first luminance value” corresponds to the reflectance 0% and the “second luminance value” corresponds to the reflectance 100%, “another luminance value” is any value (reflectance) in a range of 25% to 50% from the “first luminance value” to the “second luminance value”.

The A/D converter 103, the select circuit 110, and the black-reference-data storing unit 111 to the white-reference-data storing unit 115 (these units are equivalent to the luminance-information acquiring unit) acquire information (reflectance [%]) concerning the luminance of reflected light obtained by illuminating the white reference plate and the black reference plate with the light source 10g, a light amount of which is controlled by the light-amount control unit.

The shading correction unit 116 (equivalent to the correction processing unit) performs shading correction processing on the basis of information stored in the black-reference-data storing unit 111 to the white-reference-data storing unit 115.

In a configuration including both a white reference plate and a black reference plate, these reference plates are equivalent to the illumination target. In a configuration including only a white reference plate and having, black reference data, as a luminance value detected by a sensor in a state in which a light source is turned off, the white reference plate is equivalent to the predetermined illumination target.

Examples of the “information concerning the luminance of reflected light” include reflectance, luminance, density, and lightness.

In general, a human vision has a characteristic that a density difference of a high-density image is more easily recognized than a density difference of a low-density image. This is because a human visual sensitivity characteristic is more excellent in sensitivity to high density than sensitivity to low density.

Therefore, it is possible to perform highly accurate shading correction matching the human visual sensitivity characteristic by using, for example, a luminance value of reflected light at the reflectance 50% for the shading correction in addition to a luminance value (black reference data) of reflected light at the reflectance 0% and a luminance value (white reference data) at the reflectance 100% used in the shading correction in the past.

It goes without saying that data used for the shading correction in addition to the black reference data and the white reference data does not have to be one. For example, it is possible to perform highly accurate shading correction matching the human visual sensitivity characteristic by further using, for the shading correction, a luminance value of reflected light at the reflectance 50% and a luminance value of reflected light at the reflectance 25% (density higher than the reflectance 50%).

With the image scanning apparatus according to this embodiment having the configuration explained above, it is possible to realize highly accurate shading correction taking into account the human visual sensitivity characteristic. Consequently, even if a difference occurs in detection density among sensors as a result of the shading correction (even if a sensitivity difference due to fluctuation in linearity of the sensors affects an image quality), since the density difference is in a density region that is hardly visually recognized by humans, it is possible to realize shading correction of high quality for humans.

In this embodiment, the three half-tone generating circuits, i.e., the first half-tone generating circuit 106 to the third half-tone generating circuit 108 are provided as the half-tone generating circuit. However, the number of half-tone generating circuits is not limited to this. At least one half-tone generating circuit only has to be provided.

In the example explained in this embodiment, the functional blocks configuring the image scanning apparatus are realized by the circuits. However, the image scanning apparatus only has to be able to resultantly realize the same functions. The functional blocks are not limited to the circuits. For example, the functions of the respective functional blocks configuring the image scanning apparatus can also be realized by programs.

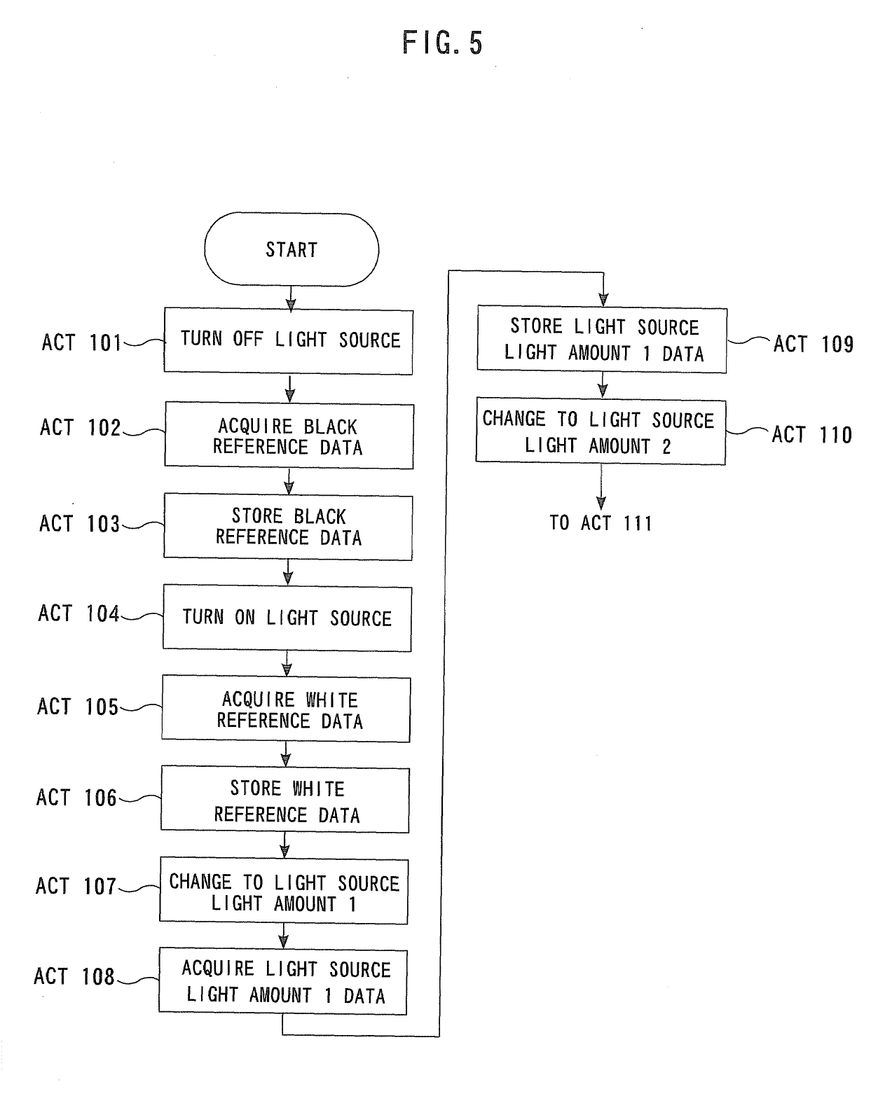

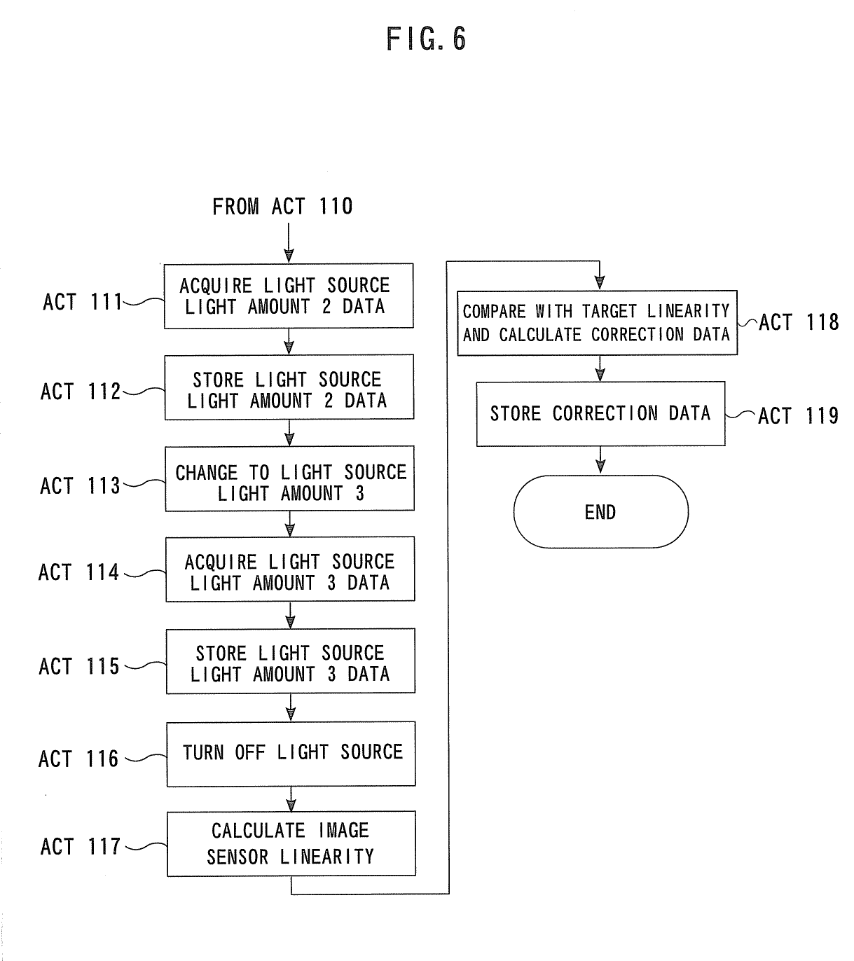

FIGS. 5 and 6 are flowcharts of a flow of processing (a shading correction method) according to the first embodiment.

First, in a state in which the light source 10g is turned off by the black-reference generating circuit 105 (ACT 101), the CPU 801 acquires black reference data by detecting a luminance value of reflected light (equivalent to the reflected light having the first luminance value) using the sensor arrays 10K to 10B (ACT 102). The CPU stores the black reference data acquired in this way in the black-reference-data storing unit 111 (ACT 103).

Subsequently, in a state in which the light source 10g is turned on (ACT 104), the CPU 801 acquires white reference data by illuminating the white reference plate and detecting a luminance value of reflected light (equivalent to the reflected light having the second luminance value) using the sensor arrays 10K to 10B (ACT 105). The CPU 801 stores the white reference data acquired in this way in the white-reference-data storing unit 115 (ACT 106).

The CPU 801 causes the light source 10g to emit light at a “light amount 1” using a forward current generated by the first half-tone generating circuit 106 (ACT 107). The CPU 801 detects the reflectance of reflected light at the “light amount 1” (equivalent to the reflected light at another luminance value) using the sensor arrays 10K to 10B (ACT 108). The CPU 801 stores reflectance data acquired in this way in the first half-tone-data storing unit 112 (ACT 109).

The CPU 801 causes the light source 10g to emit light at a “light amount 2” using a forward current generated by the second half-tone generating circuit 107 (ACT 110). The CPU 801 detects the reflectance of reflected light at the “light amount 2” (equivalent to the reflected light at another luminance value) using the sensor arrays 10K to 10B (ACT 111). The CPU 801 stores reflectance data acquired in this way in the second half-tone-data storing unit 113 (ACT 112).

The CPU 801 causes the light source 10g to emit light at a “light amount 3” using a forward current generated by the third half-tone generating circuit 108 (ACT 113). The CPU 801 detects the reflectance of reflected light at the “light amount 3” (equivalent to the reflected light at another luminance) using the sensor arrays 10K to 10B (ACT 114). The CPU 801 stores reflectance data acquired in this way in the third half-tone-data storing unit 114 (ACT 115).

The CPU 801 turns off the light source 10g (ACT 116). The CPU 801 calculates linearity of the image sensor 102 on the basis of the data stored in the respective storing units (ACT 117).

The CPU 801 compares the linearity with target linearity and calculates correction data using the correction-data calculating unit 119 (ACT 118).

The CPU 801 stores the correction data calculated by the correction-data calculating unit 119 in the correction-data storing unit 120 (ACT 119).

Even if linearity is different depending on a sensor, the difference may be able to be corrected by the shading correction in some cases (e.g., when only fluctuation on an offset side is larger but tilts are the same).

In this embodiment, the shading correction unit 116 (the correction processing unit) performs shading correction processing based on information concerning the luminance of the reflected light having the “first luminance value” and the luminance of the reflected light having the “second luminance value” prior to shading correction processing based on information concerning the luminance of the reflected light having “another luminance value”.

By performing the acquisition of the black reference data and the white reference data prior to the illumination at the light amount of the half tone in this way, it is possible to perform detection of reflected light at a light amount of a half tone in a state in which a light amount of illumination light emitted from the light source 10g is stable.

Similarly, from a viewpoint that a light amount of the light source 10g is preferably in a more stable state, the light source 10g may shift from a state of the reflectance 50% (a state of a large light emission amount) to a state of the reflectance 25% (a state of a small light emission amount).

When fluctuation in offsets is large but tilts are substantially the same or when fluctuation in tilts is large but fluctuation in offsets is small in the respective sensors as a relation between the reflectance of reflected light and detection results in the respective sensors, the shading correction in the past based only on the white reference data and the black reference data may be performed.

According to this embodiment, since the processing shown in FIGS. 5 and 6 is performed prior to an actual image scanning operation, it is possible to store a correction value in the memory 802 or the like and perform correction using the correction value stored in the memory 802 or the like when an image scanning operation is actually performed. Consequently, it is possible to obtain, in processing time substantially the same as that for processing without correction processing, an image having less image defects such as a density difference due to fluctuation in linearity without performing the operation for calculating a correction value during image scanning.

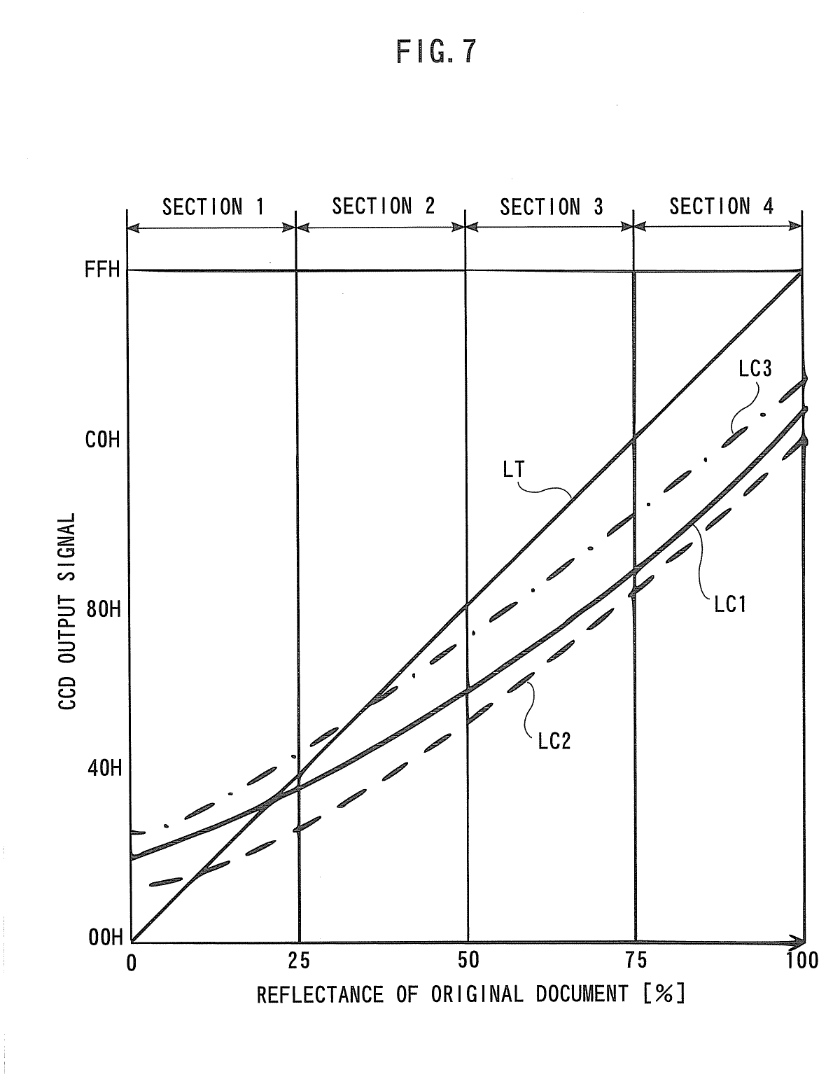

FIG. 7 is an input and output characteristic graph for explaining fluctuation in linearity before the shading correction processing is performed.

As a linear sensor, a sensor having a linear characteristic (target linearity LT shown in FIG. 7) with respect to the reflectance [%] of an original document is ideal. In general, however, the linear sensor has a tendency that a CCD output signal level is saturated as the reflectance of the original document falls.

Further, when an image in the main scanning direction is scanned by using plural image sensor arrays as in the contact image sensor, fluctuation equivalent to the number of image sensor arrays in use occurs in linearity. LC1, LC2, and LC3 in the figure indicate linearities of CCDs different from one another.

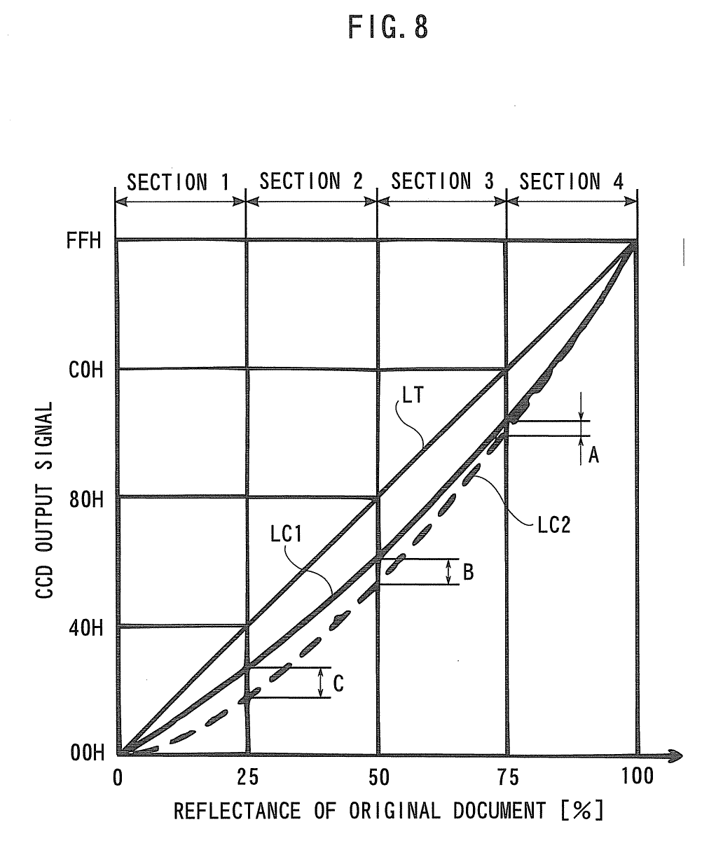

FIG. 8 is a graph for explaining linearity after the shading correction processing.

In the figure, linearity at the time when the shading correction is performed by using only the black reference data and the white reference data such that a CCD output signal is OOH at the reflectance 0% of the original document (the light source is off) and is FFH at the reflectance 100% of the original document.

When the linearity LC1 and the linearity LC2 are compared, a difference of A occurs at the reflectance 75%, a difference of B occurs at the reflectance 50%, and a difference of C occurs in the reflectance 25%. Such a difference in linearity appears as a density difference in a monochrome image and as a difference of color in a color image.

The image scanning apparatus according to this embodiment can grasp fluctuation in linearity of CCDs in advance and correct the fluctuation in linearity to prevent the density difference in the monochrome image and the difference of color in the color image from occurring.

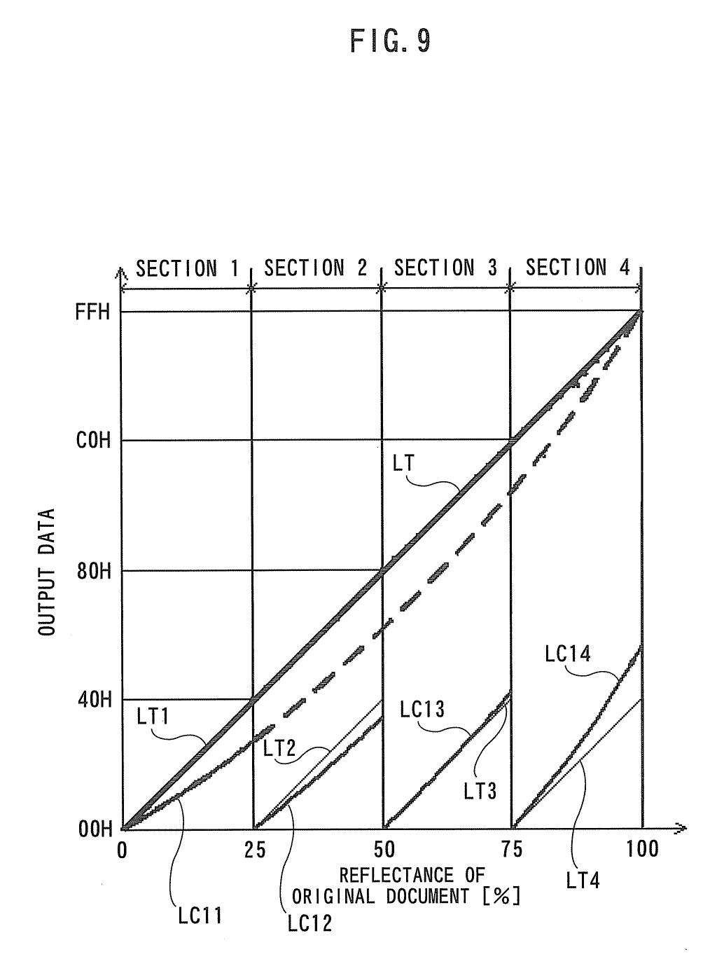

FIG. 9 is a graph for explaining a method of calculating a linear correction formula. In the figure, when an ideal input and output characteristic of a CCD sensor is represented by a primary expression, the input and output characteristic can be represented as follows:

yn=A×xn (1)

As shown in FIG. 9, when an actual sensor characteristic deviates from the ideal characteristic, according to data obtained from the black-reference generating circuit (reflectance 0%) and the half-tone generating circuit (reflectance 25%), an approximation formula of this range (reflectance 0% to 25%) is represented as follows. In the following formula, the y axis indicates an output value from the CCD sensor and the x axis indicates the reflectance of the original document:

$$\begin{matrix}y {1}^{′} = a 1 \times x 1 + b 1 \\ = a 1 \times x 1\end{matrix} \qquad ( 2 )$$

(since data of the reflectance 0% is 0, b1=0).

Therefore, since a section b1 is common at zero in a correction coefficient in this range, a difference in a tilt only has to be corrected.

Therefore, a correction formula is represented as follows:

y1=A÷a1×y1′ (3)

A range of the reflectance 25% to 50% is explained.

An approximation formula of an input and output characteristic in the range of the reflectance 25% to 50% is represented as follows:

y2′=a2×x2+b2 (4)

It is possible to obtain a difference in tilt by setting a section in x1 to 0 in both the formulas in order to set data in this range the same as an ideal input and output characteristic.

A difference from a formula of the ideal input and output characteristic is represented as follows:

y2=A÷a2×y2′ (5)

When a value of y1 in x1 is calculated and added to the above formula, it is possible to obtain data continuous from a correction value in a range of the reflectance 0% to 25%.

A correction formula is represented as follows:

y2=A÷a2×y2′+y1 (6)

An approximation formula of an input and output characteristic in the range of the reflectance 0% to 25% is represented as follows:

y1=A÷a1×y1′+y0 (7)

Therefore, in an entire region of reflectance, an approximation formula can be represented as follows:

y(n)=A÷a(n)×y(n)′+y(n−1)(n≦0) (8)

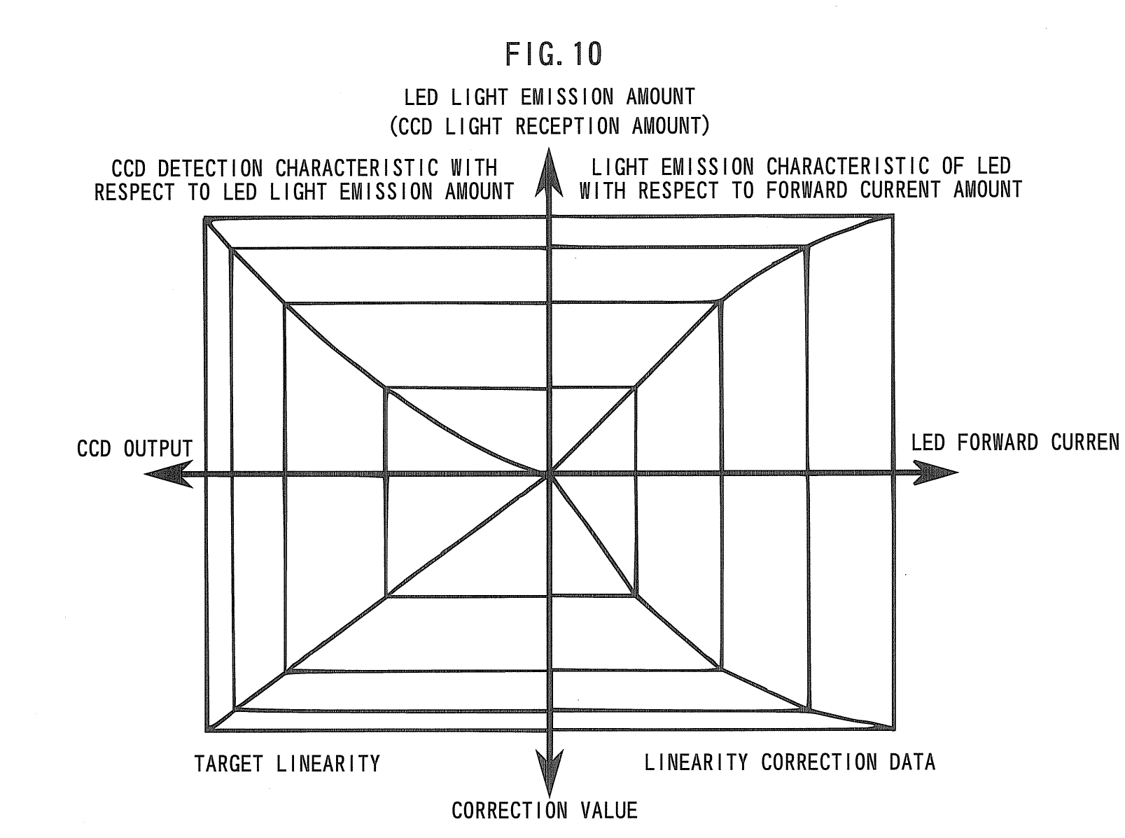

FIG. 10 is a diagram for explaining a relation among a forward current and a light emission amount of an LED, a CCD output, and linearity.

The upper right of FIG. 10 indicates a relation of a light emission amount with respect to an input forward current amount of a general LED. In general, the LED has a characteristic that, although a light emission amount linearly changes up to a certain forward current amount, linearity collapses when a forward current is equal to or larger than the certain forward current and, finally, the light emission amount does not change even if the forward current is increased.

In an example of the LED explained here, a maximum rating of a forward current amount that can be input to the LED is represented as If_MAX, the light emission amount shows a linear characteristic with respect to the forward current at If_MAX 0% to 50% and does not show the linear characteristic at If_MAX equal to or larger than 50%. This characteristic could fluctuate according to a material, a composition, a manufacturing condition, and the like of an LED chip.

The upper left of FIG. 10 indicates a relation between a light emission amount of the LED (a light reception amount of a CCD sensor) and an output characteristic of the CCD sensor. In general, a light-receiving element (a CCD sensor) does not always have a linear characteristic with respect to a light emission amount and has a characteristic that sensitivity is higher as a light reception amount is larger and sensitivity is lower as the light reception amount is smaller.

The lower left of FIG. 10 indicates a relation of target linearity with respect to a sensor light reception amount. The relation is a linear relation with respect to the sensor light reception amount.

The lower right of FIG. 10 indicates actual correction data. In this way, since the actual correction data has, with the ideal linearity as a reference, a symmetrical relation to the characteristic of the CCD output with respect to the light emission amount, it is also possible to perform correction by calculating such correction data.

### Second Embodiment

A second embodiment of the invention is explained below.

The second embodiment is a modification of the first embodiment explained above. In this embodiment, components having functions same as those already explained in the first embodiment are denoted by the same reference numerals and signs and explanation of the components is omitted.

In the example explained in the first embodiment, a forward current amount fed to the LED as the light source is adjusted in order to receive reflected light at an intermediate light amount in the CCD sensor. However, in the second embodiment, a light amount is controlled by changing light emission time of the LED.

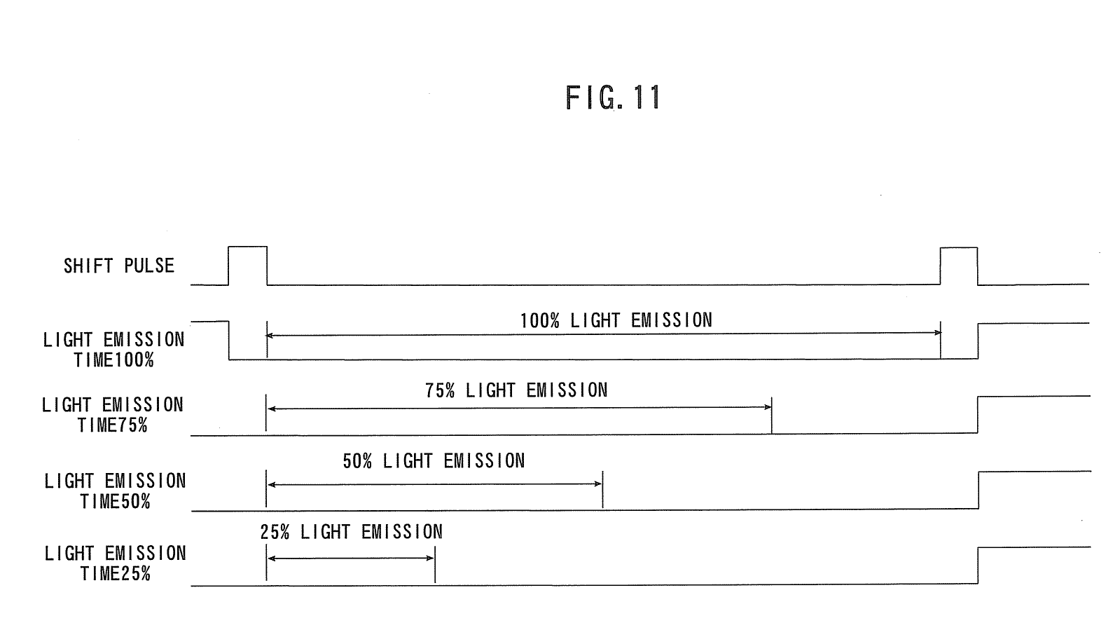

FIG. 11 is a diagram for explaining generation of a half tone by a change of LED light emission time.

It is possible to change a light emission amount of the LED by changing a forward current amount. However, when a forward current is changed, in general, wavelength during LED light emission changes. Therefore, shift of the wavelength appears as a difference of color when a color original document is scanned.

Therefore, in the following explanation of this embodiment, as an example of a method of changing a light reception amount in the CCD sensor without changing a forward current amount input to the LED, light emission time is changed during scanning of one line.

A shift pulse is a pulse indicating scanning time for one line. In a CCD line sensor, the shift pulse is used for a gate signal and the like in transferring charges of an analog shift register from a charge accumulating unit.

It is possible to acquire data equivalent to a half tone by changing, with one period of the shift pulse setting as 100%, LED light emission time to 75%, 50%, and 25% in the one period of the shift pulse.

### Third Embodiment

A third embodiment of the invention is explained below.

The third embodiment is a modification of the first and second embodiments. In this embodiment, components having functions same as those explained in the first and second embodiments are denoted by the same reference numerals and signs and explanation of the components is omitted.

In the examples explained in the first and second embodiments, in order to change a light reception amount in the CCD sensor, a forward current amount fed to the LED as the light source and light emission time of the LED are adjusted. However, in the third embodiment, a light amount is controlled by changing charge accumulation time in the CCD sensor.

Examples of parameters related to determination of the charge accumulation time include a “shift pulse period” and a “start pulse period”.

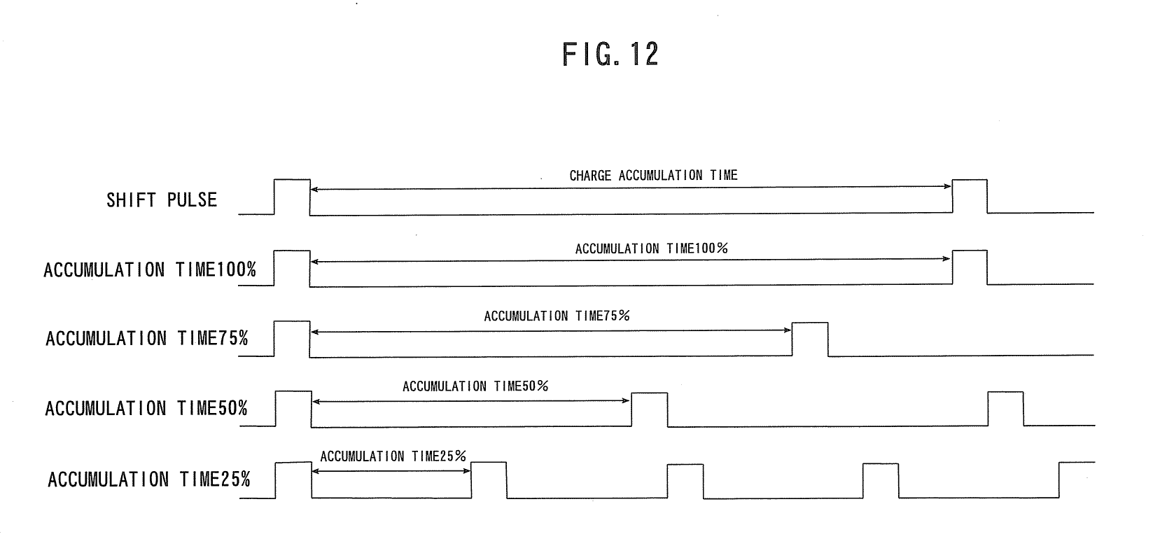

FIG. 12 is a diagram for explaining generation of a half tone by a change of the charge accumulation time.

When light emission time of the LED is changed in one period of a shift pulse, a change in a signal level of the CCD may occur according to ON and OFF operations of the LED.

In particular, when a substrate on which a CCD line sensor and the LED as the light source are connected, if ON or OFF of the LED occurs before all serially-output image data for one line are transferred, a change in a CCD output voltage is caused by fluctuation in the power supply and a GND. In particular, when an OFF state of the LED is set as a black reference, it is likely that accurate correction cannot be performed.

Therefore, in the following explanation of this embodiment, as measures against such a case, charge accumulation time in the CCD sensor is changed.

For example, when normal charge accumulation time for one line is set as 25% charge accumulation time, it is possible to perform data acquisition for calculation of correction data by setting charge accumulation time for two lines to 50%, setting charge accumulation time for three lines to 75%, and setting charge accumulation time for four lines to 100%.

A period of the shift pulse for determining the charge accumulation time is changed. However, it is also allowable to use a value obtained by adding up data for four lines at the 100% charge accumulation time, use a value obtained by adding up data for three lines at the 75% charge accumulation time, and use a value obtained by adding up data for two lines at the 50% charge accumulation time, and use data for one line at the 25% charge accumulation time without changing the shift pulse period. Consequently, it is possible to acquire half-tone data using a shift pulse of the same period. It is unnecessary to add, for example, a function for changing a pulse period to a pulse generating circuit. It is possible to realize highly accurate shading correction with a simple configuration.

In general, it is known that light emission wavelength changes when a forward current necessary for causing an LED to emit light is changed. Therefore, when a color image is scanned by using LEDs of plural colors (e.g., red, green, and blue) as light sources or when an image is scanned by a sensor having a white light source and a color filter (a three-line color sensor, etc.), if the forward current is changed to output a signal level equivalent to an intermediate density, color drift occurs in a scanned image.

On the other hand, it is possible to perform highly accurate detection of correction data by changing the charge accumulation time.

### Fourth Embodiment

A fourth embodiment of the invention is explained below.

The fourth embodiment is a modification of the first to third embodiments. In this embodiment, components having functions same as those explained in the first to third embodiments are denoted by the same reference numerals and signs and explanation of the components is omitted.

A shading correction unit (a correction processing unit) according to this embodiment performs shading correction on the basis of (1) sensitivity information concerning sensitivity, which corresponds to a light amount of illumination light from a light source, of a sensor that detects the luminance of reflected light obtained by illuminating a white reference plate and a black reference plate (the predetermined illumination target) with a light source and (2) information acquired by a luminance-information acquiring unit.

This makes it possible to realize highly accurate shading correction taking into account sensitivity that changes according to light amounts of CCD sensors.

In the examples explained in the first to third embodiments, the light source is the LED. However, the light source is not always limited to the LED. It goes without saying that, for example, an EL element can also be adopted as the light source.

As in the first to third embodiments, when the scanning optical system that can scan a color image is adopted, color illumination light tends to be dark because the color illumination light is transmitted through a filter. Therefore, it is desirable to make the color illumination light brighter.

For example, when a four-line image sensor is adopted as the scanning optical system, besides performing correction processing individually on the basis of detection values in sensors in respective lines, it is also possible to perform the correction processing on the basis of an added-up value of detection values for plural lines.

It is also allowable to store a light emission characteristic of the light source and set a light emission condition of the light source at the time when a luminance value of reflected light from an original document is detected.

In the examples explained in the first to third embodiments, illumination light having half-tone brightness has, for example, the reflectance 50% and the reflectance 25%. However, the illumination of the half tone is not limited to this. For example, it is also possible to set, on the basis of a density distribution of an image to be scanned, the illumination light of the half tone near a density region frequently used in the image and perform shading correction suitable for the image to be scanned.

The respective acts of the processing in the image scanning apparatus explained above are realized by causing the CPU 801 to execute a shading correction program stored in the memory 802.

Further, the program for causing the computer configuring the image scanning apparatus to execute the acts can be provided as the shading correction program. In the example explained in the embodiments, the program for realizing the functions for carrying out the invention is recorded in advance in the storage area provided in the apparatus. However, the program is not limited to this. The same program may be downloaded from a network to the apparatus or the same program stored in a computer-readable recording medium may be installed in the apparatus. A form of the recording medium may be any form as long as the recording medium can store the program and is a computer-readable recording medium. Specifically, examples of the recording medium include internal storage devices implemented in the computer such as a ROM and a RAM, portable storage media such as a CD-ROM, a flexible disk, a DVD disk, a magneto-optical disk, and an IC card, a database that stores a computer program, other computers and databases for the computers, and a transmission medium on a line. Functions obtained by the installation and the download in this way may realize the functions in cooperation with an OS (operating system) in the apparatus.

The program in the embodiments includes a program for dynamically generating an execution module.

According to the embodiments explained above, it is possible to highly accurately realize correction of sensitivity fluctuation caused by an individual difference of plural light-receiving element arrays in a scanning optical system in which the plural light-receiving element arrays are arranged in a row.

The present invention can be carried out in other various forms without departing from the spirit and the main characteristics thereof. Therefore, the embodiments are merely illustrations in all aspects and should not be limitedly interpreted. The scope of the invention is indicated by claims and is not restrained by the text of the specification at all. All modifications, various alterations, substitutions, and improvements belonging to a range of equivalents of claims are within the scope of the invention.

As explained above in detail, according to the invention, it is possible to provide a technique that can realize highly accurate shading correction with a simple configuration.

What is claimed is:

1. An image scanning apparatus comprising:
a light source that illuminates a predetermined illumination target;
a light-amount control unit that controls a light amount of illumination light on the predetermined illumination target by the light source such that reflected light having a first luminance value as predetermined black reference data, reflected light having a second luminance value as predetermined white reference data, and reflected light having another luminance value as at least one value between the first luminance value and the second luminance value can be obtained;
a luminance-information acquiring unit that acquires information concerning luminance of reflected light obtained by illuminating the predetermined illumination target with the light source, the light amount of which is controlled by the light-amount control unit; and
a correction processing unit that performs shading correction on the basis of information acquired by the luminance-information acquiring unit.

2. The apparatus according to claim 1, wherein the light-amount control unit controls the light source such that the other luminance value is a value closer to the first luminance value than a median in a range from the first luminance value to the second luminance value.

3. The apparatus according to claim 1, wherein the light-amount control unit controls the light source such that, when the first luminance value corresponds to 0% and the second luminance value corresponds to 100%, the other luminance value is any value in a range corresponding to 25% to 50% between the first luminance value and the second luminance value.

4. The apparatus according to claim 1, wherein the light source is at least one of an LED and an EL element.

5. The apparatus according to claim 1, wherein
the light source is an LED, and
the light-amount control unit controls the light amount by changing a forward current amount supplied to the LED.

6. The apparatus according to claim 1, wherein
the light source is an LED, and
the light-amount control unit controls the light amount by changing light emission time of the LED.

7. The apparatus according to claim 1, wherein the light-amount control unit controls the light amount by changing charge accumulation time in a sensor that detects luminance of reflected light from the predetermined illumination target.

8. The apparatus according to claim 1, wherein the correction processing unit performs the shading correction on the basis of sensitivity information concerning sensitivity, which corresponds to a light amount of illumination light from the light source, of a sensor that detects illumination of reflected light obtained by illuminating the predetermined illumination target with the light source and the information acquired by the luminance-information acquiring unit.

9. The apparatus according to claim 1, wherein the correction processing unit performs shading correction processing based on information concerning luminance of the reflected light having the first luminance value and luminance of the reflected light having the second luminance value prior to shading correction processing based on information concerning luminance of the reflected light having the other luminance value.

10. A shading correction method comprising:
controlling a light amount of illumination light on a predetermined illumination target by a light source such that reflected light having a first luminance value as predetermined black reference data, reflected light having a second luminance value as predetermined white reference data, and reflected light having other luminance values as at least one value between the first luminance value and the second luminance value are obtained;
acquiring information concerning luminance of reflected light obtained by illuminating the predetermined illumination target with the light source, the light amount of which is controlled; and
performing shading correction on the basis of the acquired information.

11. The method according to claim 10, further comprising controlling the light source such that the other luminance value is a value closer to the first luminance value than a median in a range from the first luminance value to the second luminance value.

12. The method according to claim 10, further comprising controlling the light source such that, when the first luminance value corresponds to 0% and the second luminance value corresponds to 100%, the other luminance value is any value in a range corresponding to 25% to 50% between the first luminance value and the second luminance value.

13. The method according to claim 10, wherein the light source is at least one of an LED and an EL element.

14. The method according to claim 10, wherein
the light source is an LED, and
the method further includes controlling the light amount by changing a forward current amount supplied to the LED.

15. The method according to claim 10, wherein
the light source is an LED, and
the method further includes controlling the light amount by changing light emission time of the LED.

16. The method according to claim 10, further comprising controlling the light amount by changing charge accumulation time in a sensor that detects luminance of reflected light from the predetermined illumination target.

17. The method according to claim 10, further comprising performing the shading correction on the basis of sensitivity information concerning sensitivity, which corresponds to a light amount of illumination light from the light source, of a sensor that detects illumination of reflected light obtained by illuminating the predetermined illumination target with the light source and the acquired information.

18. The method according to claim 10, further comprising performing shading correction processing based on information concerning luminance of the reflected light having the first luminance value and luminance of the reflected light having the second luminance value prior to shading correction processing based on information concerning luminance of the reflected light having the other luminance value.

19. A shading correction program for causing a computer to execute processing for:
controlling a light amount of illumination light on a predetermined illumination target by a light source such that reflected light having a first luminance value as predetermined black reference data, reflected light having a second luminance value as predetermined white reference data, and reflected light having other luminance values as at least one value between the first luminance value and the second luminance value are obtained;
acquiring information concerning the luminance of reflected light obtained by illuminating the predetermined illumination target with the light source, the light amount of which is controlled; and
performing shading correction on the basis of the acquired information.

20. The program according to claim 19, further causing the computer to execute processing for controlling the light source such that the other luminance value is a value closer to the first luminance value than a median in a range from the first luminance value to the second luminance value.
